(19) United States
(12) Patent Application Publication
(10) Pub. No.: US 2005/0268024 A1
(43) Pub. Date: Dec. 1, 2005

(54) Memory controller for use in multi-thread pipeline bus system and memory control method

(75) Inventors: Yoon-Bum Seo, Seoul (KR); Jong-Chul Shin, Suwon-si (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/032,414

(22) Filed: Jan. 10, 2005

(30) Foreign Application Priority Data
May 28, 2004 (KR) 04-38448

(51) Int. Cl. G06F 12/00

(52) U.S. Cl. 711/5; 711/105

(57) ABSTRACT

In a memory control method in a multiple-thread pipeline system, addresses of a plurality of banks to be accessed in a memory unit are received in sequence from a master. For each of the plurality of banks, it is determined whether an address that corresponds to the bank is input from the master when read/write commands are output to the memory unit. The read/write commands including any one of open page information and auto-precharge information are output to the memory unit when a result of the determination indicates that an address that corresponds to the bank is input.

### CROSS-REFERENCE TO RELATED APPLICATIONS

This U.S. non-provisional patent application claims priority under 35 U.S.C. § 119 of Korean Patent Application 2004-38448 filed on May 28, 2004, the entire contents of which are hereby incorporated by reference.

### BACKGROUND OF THE INVENTION

The present invention relates to a data processing system and more specifically to a memory controller for controlling access to dynamic random access memory.

Synchronized dynamic random access memory (SDRAM) devices are utilized in various computing devices and are accessed by various types of processors. An SDRAM controller generates signals for controlling read and write operations in response to commands and addresses from a master, for example a master processor. When a memory cell of an SDRAM is accessed, a row (or a word line) on which the memory cell is placed is activated. One function of the SDRAM controller is to determine whether a row to be accessed is presently activated. If the row is not activated, the SDRAM controller activates the row prior to a read or write access involving the row. The other function the SRAM controller is to inactivate a previously activated row when access is granted to a new row.

The SDRAM, as well known, performs a precharge operation following read/write operations in order to maintain the status of stored data. When the precharge operation is performed, a formerly activated row is inactivated and columns (or bit lines) are set to a precharge voltage (e.g., VCC/2). This precharge operation typically requires a few clock cycles, for example two or three clock cycles, to complete. When rows in the same bank of the SDRAM are continuously accessed, the precharge operation should be performed even though it is not required. As illustrated in FIG. 1, when a row in a given bank (e.g., bank A) is accessed and a row in another bank (e.g., bank B) is accessed, additional clock cycles (interval A in FIG. 1) are needed for performing a precharge operation on the previously selected bank A. During the precharge time period, access to the memory cells is suspended. Therefore, the access rate of the SDRAM is affected by the precharge operation of the SDRAM. In particular, as the access frequency of an SDRAM increases, the access rate of the SDRAM is affected to a higher degree by the precharge operation.

### SUMMARY OF THE INVENTION

The present invention is directed to a system and method by which a precharge operation of the SDRAM is controlled in a more efficient or optimal manner, so as to improve access rate of the SDRAM, while still accommodating the need for a precharge operation.

An aspect of the present invention is to provide a memory controller and method capable of reducing access time.

Another aspect of the present invention is to provide a memory controller and method capable of effectively controlling a precharge operation of the SDRAM.

In a first aspect, the present invention is directed to a memory control method in a multiple-thread pipeline system. According to the method, addresses of a plurality of banks to be accessed in a memory unit are received in sequence from a master. For each of the plurality of banks, it is determined whether an address that corresponds to the bank is input from the master when read/write commands are output to the memory unit. The read/write commands including any one of open page information and auto-precharge information are output to the memory unit when a result of the determination indicates that an address that corresponds to the bank is input.

In one embodiment, outputting the read/write commands comprises: determining for each bank of the plurality of banks whether a present row address is equal to a next row address of the sequence of received addresses; outputting the read/write commands including the open page information if the present row address is equal to the next row address; and outputting the read/write commands including the auto-precharge information if the present row address is equal to the next row address.

In another embodiment, when the determination result indicates that an address that corresponds to the bank is not input from the master, further comprising performing a precharge operation on the identical bank during an access operation of another bank of the plurality of banks.

In another embodiment, the method further comprises determining for each bank of the plurality of banks whether a next row address that corresponds to the bank is input; determining whether the next row address that corresponds to the bank is equal to a row address corresponding to a previously activated row of the bank; and outputting to the memory unit a precharge command to initiate performing the precharge operation on the bank when the next row address that corresponds to the bank is not equal to the row address corresponding to the previously activated row of the bank.

In another embodiment, the precharge operation is performed on the bank during an access operation of the another bank of the plurality of banks. In another embodiment, the memory unit comprises a DDR SDRAM.

In another aspect, the present invention is directed to a memory controller for controlling a memory unit including a plurality of banks in a multiple-thread pipeline system. A plurality of FIFO memories each store in sequence addresses and commands for a corresponding bank of the plurality of banks of the memory unit. A plurality of first state machines correspond to each of the FIFO memories, each of the first state machines generating an active command and read/write commands as an output for an access operation of a corresponding bank of the memory unit in response to the addresses and commands stored in the corresponding FIFO memory. Each of the first state machines determines whether an address of the corresponding bank of the memory unit is input to the corresponding FIFO memory when the read/write commands are output to the memory unit.

In one embodiment, in each of the first state machines, if an address of a corresponding bank of the memory unit is input to the corresponding FIFO memory when the read/write commands are output, the first state machine determines whether a present row address is identical to a next row address.

In another embodiment, in each of the first state machines, if the present row address is equal to the next row address, the first state machine outputs read/write commands including open page information to the memory unit.

In another embodiment, in each of the first state machines, if the present row address is not equal to the next row address, the first state machine outputs read/write commands including auto-precharge information to the memory unit.

In another embodiment, in each of the first state machines, if an address of a corresponding bank of the memory unit is not input to the corresponding FIFO memory when the read/write commands are output, the first state machine continues to monitor whether the address of the corresponding bank is input.

In another embodiment, in each of the first state machines, if an address of a corresponding bank of the memory unit is input, the first state machine issues a precharge command so as to perform a precharge operation of the corresponding bank of the memory unit during an access operation of another bank of the plurality of banks of the memory unit.

In another embodiment, the memory controller further comprises a multiplexer that receives the outputs of the first state machines; a second state machine for controlling the multiplexer in response to the input bank information of the address so as to select the output of any one of the first state machines; and a timing generator for controlling an access timing of the memory unit in response to an output of the first state machine selected by the multiplexer.

In another embodiment, the memory includes a DDR SDRAM.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention. In the drawings:

FIG. 1 is a timing diagram that illustrates the timing of a precharge operation of a conventional memory controller undergoing access cycles;

FIG. 2 is a schematic block diagram of a memory controller in accordance with the present invention;

FIG. 3 is a flow diagram that illustrates a control operation of a memory controller in accordance with the present invention; and

FIGS. 4 and 5 are timing diagrams that illustrate a control operation of the memory controller in accordance with the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the invention to those skilled in the art. Like numerals refer to like elements throughout the specification.

Hereinafter, an exemplary embodiment of the present invention will be described in conjunction with the accompanying drawings.

A memory controller of the present invention is adapted to a multi-thread pipeline bus system. In such a system, the memory controller receives not only addresses and commands required for a present access cycle but also those required for subsequent access cycles. In the controller and method of the present invention, when read or write commands are output, it is determined whether the address required for the next access cycle is identical to the present address. Depending on a result of the determination, auto-precharge or open page read/write commands may be output to the memory device. In addition, if the address required for the next access cycle is not available when the read/write commands are output to the memory device, a precharge operation is performed during an access operation of another bank in the memory device, according to the subsequent input address. This procedure will be explained in further detail below. This precharge operation scheduling system and method of the present invention reduces access time of the memory device and system performance is thus improved.

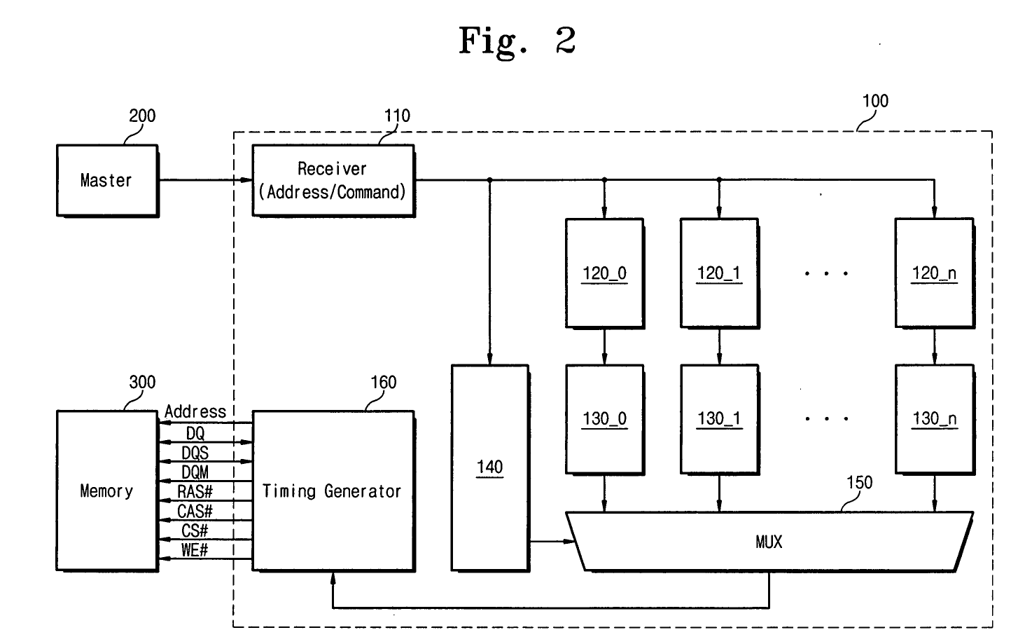

FIG. 2 is a schematic block diagram of a memory controller in accordance with the present invention. Referring to FIG. 2, the memory controller 100 of the present invention is used in a multi-thread pipeline bus system and controls access operations of the memory 300 (e.g., a read operation, a write operation, a precharge operation, etc.) in response to the addresses and commands received from the master 200. The memory controller 100 includes a receiver 110, a plurality of FIFO memories 120_i (i=0˜n), a plurality of first state machines 130_i, a second state machine 140, a multiplexer 150, and a timing generator 160. Each of the FIFO memories 120_i has a corresponding first state machine 130_i, respectively. In one embodiment, the number of the FIFO memories 120_i is equal to a number of banks of the memory. It is however well known to those skilled in the art that the FIFO memories 120_i can optionally be embodied to correspond to a plurality of memory devices, respectively, even in the case where each memory device includes a plurality of banks.

A receiver 110 receives addresses and commands from the master 200, for example a master processor. The input address includes information related to the rows, columns, and banks of the memory devices to be accessed. The input address is stored in a corresponding one of the FIFO memories 120_i in accordance with the bank information. Each of the first state machines 130_i outputs information (e.g., an active command, a read/write command, a precharge command, an address, etc.) required for an access of the memory device 300 in response to the addresses and commands stored in each corresponding FIFO memory. The second state machine 140 operates to schedule the first state machines 130_i with respect to the bank information output from the receiver 110. The multiplexer 150 selects the output of one of the first state machines 130_i in response to control information output by the second state machine 140. The timing generator 160 controls the timing of memory access operations of the memory 300 in response to the information generated by the first state machines 130_i, as selected by the multiplexer 150.

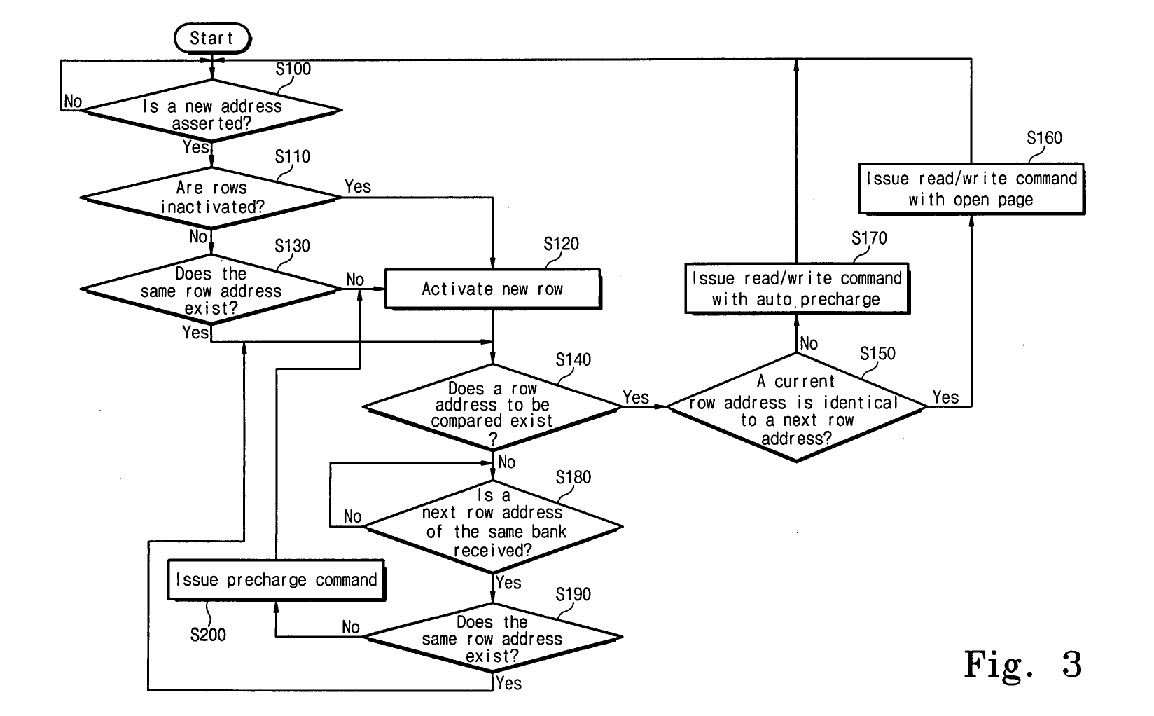

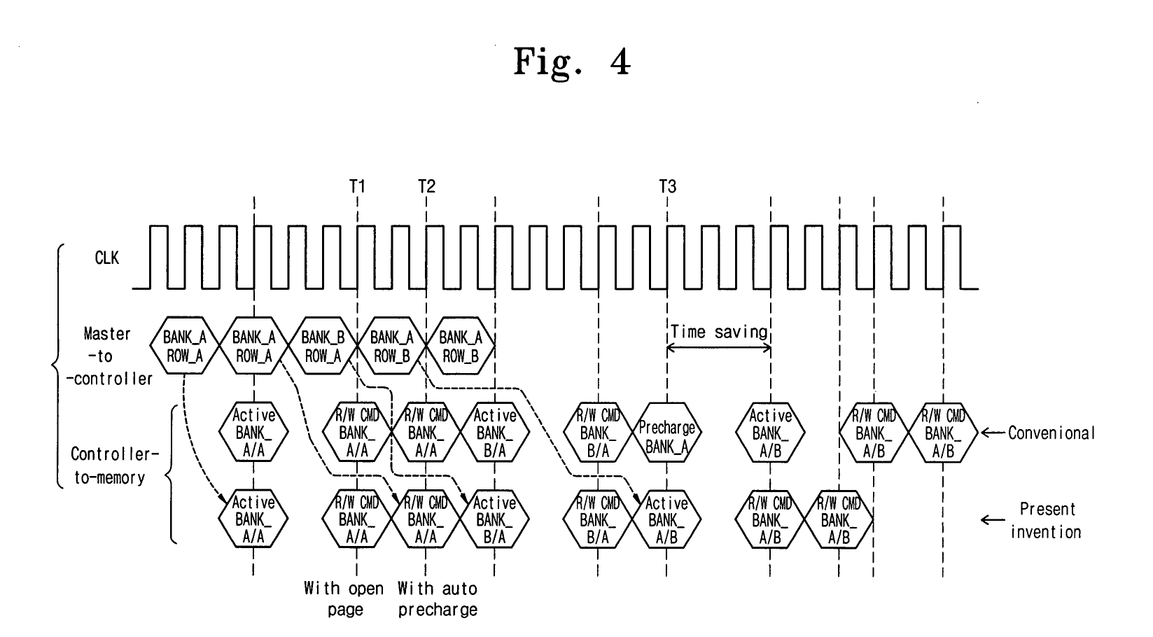

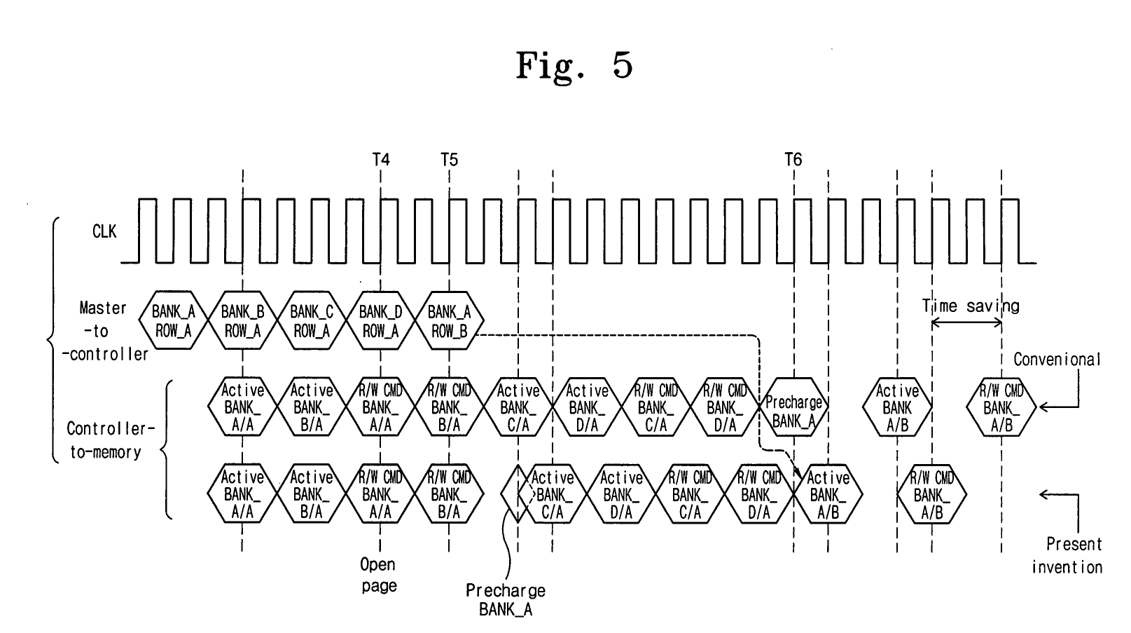

Hereinafter, the control operation of the memory controller will be explained in further detail with reference to FIGS. 3, 4 and 5. FIG. 3 is a flow diagram that illustrates a control operation of the memory controller in accordance with the present invention. FIGS. 4 and 5 are timing diagrams that explain a control operation of the memory controller in accordance with the present invention.

In a multi-thread pipeline bus system employing the memory controller 110 of the present invention, addresses related to a memory access operation are sequentially provided for the memory controller 100. The memory controller 100 stores the multiple addresses provided from the master 200 in corresponding memory devices. In one embodiment, the operation described below is carried out by the first state machines 130_i, and will be explained on the basis of the first state machine 130_0 for convenience. That is, an access operation with respect to a bank A will be fully explained in detail below; however the described operation is likewise applicable to other banks in the memory device or devices.

The first state machine 130_0 initially determines whether a new address is asserted (step S100). With reference to FIGS. 3 and 4, assuming a new address BANK_A and ROW_A is input, the first state machine 130_0 determines whether rows of the memory bank corresponding to the first state machine 130_0, for example bank A, are activated or inactivated (step S110). It is well known to those skilled in the art that the first state machines 130_i are arranged to record previous operation states of the corresponding memory banks. If rows of bank A were previously inactivated, then the state machine issues a command to activate the rows of bank (step S120).

The operation of activating rows (step S120) is performed in the following manner, as well known in the art. The first state machine 130_0 outputs an active command including a combination of control signals and a row address. The active command including the control signals and the row address is provided to the timing generator 160 through the multiplexer 150 under control of the second state machine 140. The timing generator 160 then outputs the input active command and the associated row address to the memory device 300 according to a timing protocol. In the above process, a new row of memory bank A may be activated. As well known to those skilled in the art, column address and read/write commands may be output to the bank A after the row activate command is transmitted to the memory device 300. The process of transmitting the column address and the read/write command is carried out as explained above. Following this, the process proceeds to step S140.

Returning to step S110, if the desired row in bank A is activated, the first state machine 130_0 next determines whether the present row address is equal to the previously activated row address (step S130). If they are not equal, the process proceeds to step S120. If they are equal, the process proceeds to step S140. In step S140, the first state machine 130_0 determines whether a next row address to be compared with the present row address is present in the corresponding FIFO memory 120_0. If it exists, the state machine 130_0 next determines whether the present row address is identical to the next row address (step S150). In other words, when the read/write commands are output to the bank (for example, at time T1 in FIG. 4), the first state machine 130_0 determines whether the row address stored in a corresponding FIFO memory 120_0 is identical to the row address corresponding to the presently activated row. That is, when the read/write commands are output to a corresponding bank (T1), the first state machine 130_0 determines whether the row address in a presently performed access cycle (i.e., the present row address) is identical to the row address in an access cycle to be performed next (i.e., the next row address).

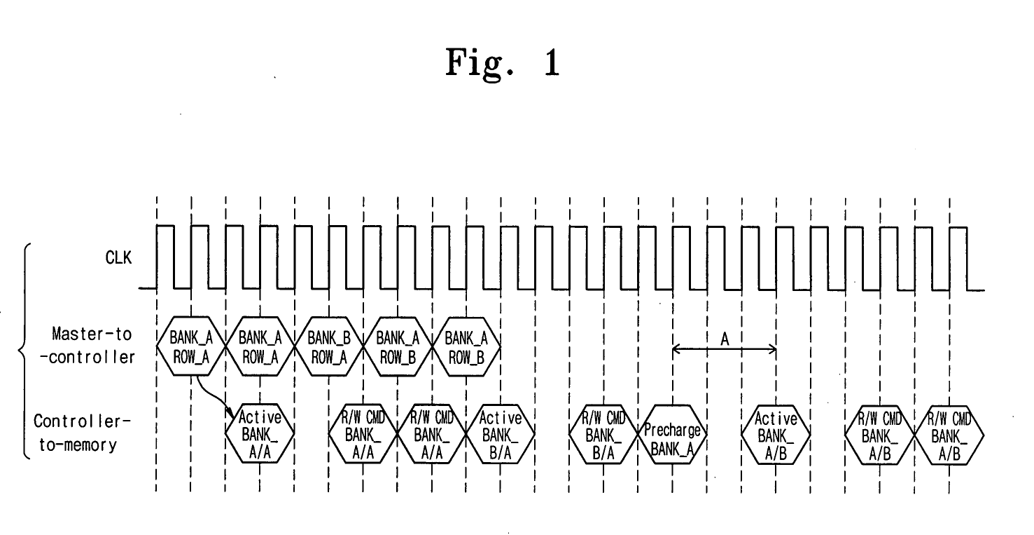

If the present row address is identical to the next row address, the first state machine 130_0 issues an open page read/write command so as to make the row corresponding to the present row address continuously activated (step S160). The open page read/write commands issued from the first state machine 130_0 are sent to the timing generator 160 through the multiplexer 150 under the control of the second state machine 140. Following this, the operation returns to step S100. Returning to step S150, if the present row address is not identical to the next row address, the first state machine 130_0 issues an auto-precharge read/write command so as to inactivate the row corresponding to the present row address (step S170). That is to say, an access operation is carried out without an active command for activating the row corresponding to the next row address as illustrated in FIG. 4. Access time is thus reduced. The auto-precharge read/write commands output from the first state machine 130_0 may be sent to the timing generator 160 through the multiplexer 150 under control of the second state machine 140. Following this, the process proceeds to step S100. Since the auto-precharge read/write commands are transmitted to the memory 300, additional clock cycles, such as cycles A in FIG. 1, are not required to carry out the additional precharge commands. Therefore, access time for the memory device can be reduced in the present invention by the amount of the additional clock cycles A that would otherwise be required for the precharge operation.

Returning to step S140 of FIG. 3, if a next row address to be compared with the present row address is not present in the corresponding FIFO memory 120_0, the first state machine 120_0 of the first bank determines whether the next row address of the same bank is input (step S180). For instance, referring to FIG. 5, the first state machine 130_0 determines whether a next row address to be compared with a present row address ROW_A exists in the corresponding FIFO memory 120_0 at each time at which the read/write commands are output (for example, times T4 and T5 in FIG. 5). Since the next row address to be compared with the present row address ROW_A does not exist in the corresponding FIFO memory 120_0 at point T4, the first state machine 130_0 continues to determine (at step S180) whether the next row address to be compared with the present row address ROW_A is input to the corresponding FIFO memory 120_0.

At the time when the next row address ROW_B to be compared with the present row address ROW_A is input to the corresponding FIFO memory 120_0, the first state machine 130_0 next proceeds to step S190 to determine whether the next row address of a given bank is identical to the row address corresponding to a previously activated row of the bank. If the next row address of the given bank is not identical to the row address corresponding to the previously activated row of the bank, for example at time T5 of FIG. 5, the first state machine 130_0 issues a precharge command. The precharge command is sent to the timing generator 160 through the multiplexer 150 under the control of the second state machine 140. The timing generator 160 outputs a precharge command with respect to bank A at a proper point in time (step S200). In this configuration and method, the point in time at which the precharge command is output is determined by the access cycles of the other banks, and a precharge operation of bank A can be performed during an access operation of another bank. An access operation with respect to the address input at step S180 can be initiated when the following read/write commands are output (for example at step S140). In this manner, the memory device access time can be decreased, since additional clock cycles are not required for a precharge operation with respect to the bank A, as bank A is precharged during an access of another bank in the memory system.

In conclusion, when read/write commands are output in the memory control system and method of the present invention, a determination is made as to whether a present requested row address and a next requested row address of the same bank are equal. According to the result of the determination, open page or auto-precharge read/write commands are issued to a memory. If the next row address to be compared with the present row address does not exist, or if an access of the identical bank is infrequent or does not exist for a long period of time, a previously selected row is continuously maintained in an activated state until the next row address is input. If the next row address to be compared with the present row address is input, a precharge operation is performed during an access operation of another bank in the system depending on whether the next row address is identical to the previous row address.

As described above, in the present invention, precharge operation scheduling is controlled when read/write commands are output. This results in reduced access time of the associated SDRAM. Moreover, a system incorporating such a memory controller and an SDRAM offers improved performance over conventional systems.

While this invention has been particularly described with reference to preferred embodiments thereof, it will be understood by those skilled in the art that various changes in form and details may be made herein without departing from the spirit and scope of the invention as defined by the appended claims.

1. A memory control method in a multiple-thread pipeline system, comprising:
a) receiving in sequence addresses of a plurality of banks to be accessed in a memory unit from a master;
b) determining for each of the plurality of banks whether an address that corresponds to the bank is input from the master when read/write commands are output to the memory unit; and
c) outputting the read/write commands including any one of open page information and auto-precharge information to the memory unit when a result of the determining step (b) indicates that an address that corresponds to the bank is input.

2. The method of claim 1, wherein the step (c) comprises:
determining for each bank of the plurality of banks whether a present row address is equal to a next row address of the sequence of received addresses;
outputting the read/write commands including the open page information if the present row address is equal to the next row address; and
outputting the read/write commands including the auto-precharge information if the present row address is equal to the next row address.

3. The method of claim 1, wherein when the determining result of the step (b) indicates that an address that corresponds to the bank is not input from the master, further comprising performing a precharge operation on the identical bank during an access operation of another bank of the plurality of banks.

4. The method of claim 3 further comprising:
determining for each bank of the plurality of banks whether a next row address that corresponds to the bank is input;
determining whether the next row address that corresponds to the bank is equal to a row address corresponding to a previously activated row of the bank; and
outputting to the memory unit a precharge command to initiate performing the precharge operation on the bank when the next row address that corresponds to the bank is not equal to the row address corresponding to the previously activated row of the bank.

5. The method of claim 4, wherein the precharge operation is performed on the bank during an access operation of the another bank of the plurality of banks.

6. The method of claim 1, wherein the memory unit comprises a DDR SDRAM.

7. A memory controller for controlling for controlling a memory unit including a plurality of banks in a multiple-thread pipeline system, comprising:
a plurality of FIFO memories that each store in sequence addresses and commands for a corresponding bank of the plurality of banks of the memory unit; and
a plurality of first state machines which correspond to each of the FIFO memories, each of the first state machines generating an active command and read/write commands as an output for an access operation of a corresponding bank of the memory unit in response to the addresses and commands stored in the corresponding FIFO memory,
wherein each of the first state machines determines whether an address of the corresponding bank of the memory unit is input to the corresponding FIFO memory when the read/write commands are output to the memory unit.

8. The memory controller of claim 7, wherein in each of the first state machines, if an address of a corresponding bank of the memory unit is input to the corresponding FIFO memory when the read/write commands are output, the first state machine determines whether a present row address is identical to a next row address.

9. The memory controller of claim 8, wherein in each of the first state machines, if the present row address is equal to the next row address, the first state machine outputs read/write commands including open page information to the memory unit.

10. The memory controller of claim 8, wherein in each of the first state machines, if the present row address is not equal to the next row address, the first state machine outputs read/write commands including auto-precharge information to the memory unit.

11. The memory controller of claim 8, wherein in each of the first state machines, if an address of a corresponding bank of the memory unit is not input to the corresponding FIFO memory when the read/write commands are output, the first state machine continues to monitor whether the address of the corresponding bank is input.

12. The memory controller of claim 11, wherein in each of the first state machines, if an address of a corresponding bank of the memory unit is input, the first state machine issues a precharge command so as to perform a precharge operation of the corresponding bank of the memory unit during an access operation of another bank of the plurality of banks of the memory unit.

13. The memory controller of claim 7, further comprising:
a multiplexer that receives the outputs of the first state machines;
a second state machine for controlling the multiplexer in response to the input bank information of the address so as to select the output of any one of the first state machines; and
a timing generator for controlling an access timing of the memory unit in response to an output of the first state machine selected by the multiplexer.

14. The memory controller of claim 7, wherein the memory includes a DDR SDRAM.
